(19) United States
(12) Patent Application Publication
(10) Pub. No.: US 2019/0075507 A1
(43) Pub. Date: Mar. 7, 2019

(54) Radio-Rate-Transformer: A Practical and Legal Radio Combo Transforming VHF/UHF Radio Communication to Gigahertz Broadband Radio Communication

(71) Applicant: Jiejun Kong, JURUPA VALLEY, CA (US)

(72) Inventor: Jiejun Kong, JURUPA VALLEY, CA (US)

(21) Appl. No.: 15/697,416

(22) Filed: Sep. 6, 2017

(51) Int. Cl. H04W 40/20; H04W 40/02

(52) U.S. Cl. CPC H04W 40/20; H04W 40/06; H04W 40/026

(57) ABSTRACT

The invention being patented pertains to providing long-range high-speed broadband communication between two common vehicles at pairwise distance possibly as distant as 3 to 30 kilometers in the presence of vehicle mobility. Unlike some existing systems using illegally large transmission power settings, the invention is fully-compliant to FCC regulations. Unlike some existing systems which lack viable means to implement precise alignment for FCC-compliant directional gigahertz digital radios, we use FCC-compliant VHF/UHF radios to acquire critical geo-location information of the mobile targets, then the directional antenna of the gigahertz radio can be precisely aligned to achieve high-speed broadband data communication at long-range LoS distance. For example, our field tests have proven that a pair of 8-watt handheld VHF/UHF radios can communicate in 1200 bps rate at 20 km LoS distance; and 2 Mbps to 12 Mbps broadband data rate can be achieved at 10 km LoS distance for a mobile pair of 20 dBm transceivers plus 16 dBi antennas, or at 23 km LoS distance for a temporary fixed pair of 27 dBm transceivers plus 22 dBi antennas. The invention is practical and legal for mobile vehicles.

### FIELD OF THE INVENTION

The field of the invention pertains generally to wireless data communication, more particularly point-to-point wireless communication between two common vehicles (automobiles, boats, ships, buoys, rotorcrafts and blimps) at pairwise distance of as large as 3 kilometers to 30 kilometers, more particularly authorities like FCC have different rules regulating radios operating at different frequencies, more particularly the transmission power of many VHF/UHF radios are allowed to be 25 watts or greater (ITU-R M.489, FCC 47CFR90, FCC 47CFR97) while the maximal transmission power of the 900 MHz and gigahertz broadband radios is only 1 watt (FCC 47CFR15), more particularly the slow VHF/UHF radios can use omni-directional antenna to transmit data at several Kbps (kilo bits per second) rate over 30-kilometer distance while gigahertz broadband radios must rely on directional antenna to transmit data at a much higher Mbps (mega bits per second) rate over a comparable distance, more particularly we invent a new system using slow VHF/UHF radios to exchange GPS position coordinates so that the directional antennas of the high-speed broadband radios can be aligned properly. The practical system is legal given the current FCC rules or ITU-R rules.

### BACKGROUND OF THE INVENTION

We use the terms “VHF” and “UHF” defined by the IEEE (Institute of Electrical and Electronics Engineers) organization. VHF refers to radio frequencies in the range between 30 MHz and 300 MHz by both the IEEE and the ITU (International Telecommunication Union). However, in IEEE Std 521-2002 Standard Letter Designations for Radar-Frequency Bands, the IEEE defines the UHF radar band as frequencies between 300 MHz and 1 GHz, while the ITU's designation for UHF is in the range between 300 MHz and 3 GHz. We adopt the IEEE designations so that the term “VHF/UHF radio” refers to a radio operating at a frequency less than 1 GHz. Examples include amateur radios (aka. HAM radios) operating in 2 m band (144-148 MHz in US) or 70 cm band (420-450 MHz in US), marine VHF radios operating in 2 m band (156 MHz or 157 MHz), business VHF radios operating in 2 m band (151 MHz, 154 MHz or 158 MHz), and so on. Nowadays the typical data speed implemented over VHF/UHF radio links is measured in Kbps, such as 1.2 Kbps, 4.8 Kbps or 9.6 Kbps available on commercial VHF/UHF radios sold by Motorola, Kenwood, Yaesu, I-COM, et al.

On the other hand, radios operating at gigahertz bands, including IEEE L-band (1-2 GHz), S-band (2-4 GHz), C-band (4-8 GHz), X-band (8-12 GHz), Ku-band (12-18 GHz), K-band (18-27 GHz), and so on, can implement high-speed wireless broadband communication with typical data speed larger than 1 Mbps, in some ideal cases larger than 1 Gbps. Examples include Ubiquiti's 150 Mbps RocketM radios operating at 2.4 GHz S-band or 5 GHz C-band, and 2 Gbps AirFiber24 HD radios operating at 24 GHz K-band.

The VHF/UHF and gigahertz broadband radios share the following characteristics:
Line-of-sight or near-line-of-sight requirement: By the constraints in physics science, it is difficult for the radio wave to bypass a small obstacle with a size comparable to the wavelength or to penetrate a solid obstacle thicker than several meters. Thus the constraint of line-of-sight (LoS) between the transmitter and the receiver is applied to long distance VHF/UHF and gigahertz wireless communication.
Communication range overlap between omni-directional VHF/UHF and directional gigahertz band transmissions: Authorities like FCC have different rules regulating radios operating at different frequencies, more particularly the transmission power of many VHF/UHF radios are allowed to be 25 watts or greater¹ while the maximal transmission power of the 900 MHz and gigahertz broadband radios is only 1 watt (FCC 47CFR15). Therefore the slow VHF/UHF radios can use omni-directional antenna to transmit data at several Kbps rate over 30-kilometer distance while gigahertz broadband radios must rely on directional antenna to transmit data at a much higher Mbps rate over a comparable distance, ¹—In ITU-R M.489, FCC 47CFR90, FCC 47CFR97, the maximal transmission power of marine VHF radios is 25 watts, of business VHF/UHF radios is typically 50 watts, of amateur/HAM VHF/UHF radios is typically 1500 watts.

In details, wireless transmission power is normally measured by two common metrics: (1) Maximum transmitter output power, fed into the antenna; and (2) Maximum Effective Isotropic Radiated Power (EIRP), transmitted into air after going through the antenna. The EIRP is approximated by simply adding the transmitter output power, in dBm, to the antenna gain in dBi, and adding cable loss if there is loss in the cable feeding the antenna. In most national and international standards, for instance, in the United States, several of the FCC 47 part 15 rules govern the transmit power permitted in the unlicensed frequency bands. In all cases, including the least restrained fixed point-to-point cases, the maximum transmitter output power must not exceed 30 dBm (1 watt). In addition, the maximum EIRP is typically 4 watts (36 dBm), which is the sum of 30 dBm transmitter output power and 6 dBi antenna gain, except in a fixed point-to-point link scenario, where the maximum EIRP allowed is 30 dBm transmitter output power plus 23 dBi of antenna gain for the 5.15-5.25 GHz band and unbounded antenna gain for the 5.725-5.85 GHz band (FCC 47 rules section 15.245, 15.247, 15.249, 15.407). Moreover, in 2.40-2.4835 GHz band we can increase the antenna gain to get an EIRP above 36 dBm but for every 3 dBi increase of antenna gain we must reduce the transmitter output power by 1 dBm (section 15.245, 15.247, 15.249). The table below shows the combinations of allowed transmitter output power plus antenna gain and the resulting EIRP in 2.4-2.4835 GHz band. The table is not applicable to 5.15-5.25 GHz or 5.725-5.85 GHz band, where 1 dBm transmitter output power reduction must be applied to every 1 dBi antenna gain so that the resulting EIRP stays as 36 dBm (or 53 dBm in case of 5.15-5.25 GHz fixed point-to-point scenarios).

| Transmitter | | | | |
|---|---|---|---|---|
| Output Power (dBm) | + | Antenna Gain (dBi) | = | EIRP (dBm) |
| 30 | + | 6 | = | 36 |
| 29 | + | 9 | = | 38 |
| 28 | + | 12 | = | 40 |
| 27 | + | 15 | = | 42 |
| 26 | + | 18 | = | 44 |
| 25 | + | 21 | = | 46 |
| 24 | + | 24 | = | 48 |
| 23 | + | 27 | = | 50 |
| 22 | + | 30 | = | 52 |

Mobile vehicle can be implemented as “cell-on-wheels” or temporary fixed transmitters as in FCC-13-39, page 3500, footnote 2 states that “We propose the term ‘fixed’ in the Further Notice infra to describe an RF source that is physically secured at one location and is not able to be easily moved to another location while transmitting. Temporary fixed transmitters such as a ‘cell-on-wheels’ (COW) or a temporary fixed earth station (TFES) are considered fixed sources which may be able to be easily moved to another location, but since these types of transmitters are not licensed to transmit while in motion they would also conform to the proposed description of the term ‘fixed RF source’.”

In summary, an FCC-compliant vehicular communication on gigahertz broadband radios should work in either option described blow:
1. A mobile vehicle can function as a temporary fixed transmitter operating at 5.15-5.25 GHz band with 30 dBm transmitter output power and 23 dBi antenna gain or at 5.725-5.85 GHz band with 30 dBm transmitter output power and even larger antenna gain, only if the vehicle will not transmit on the gigahertz radio when moving to a new location. In other words, when it moves to another location, it maintains radio silence on the gigahertz radio; and it starts transmission only after it arrives at the new location.
2. Otherwise, the mobile vehicle must follow the rule described in the above table, i.e., set to 30 dBm transmitter output power and 6 dBi antenna gain, or in 2.4 GHz band get 3 dBi increase of antenna gain by reducing every 1 dBm transmitter output power.

### OBJECTS OF THE INVENTION

It is an object of this invention to create an FCC-compliant long-distance broadband communication system for millions of mobile vehicles. In particular, we meet the following constraints:
Fully compliant to FCC regulation: The system described in this application is fully compliant to the related FCC rules. Unlike us, some existing products use omni-directional antenna with illegally large transmission power setting which violates FCC regulations; some other products use directional antenna with legal transmission power setting but they lack the proper means to align their directional antennas when at least one of the communicating pair is mobile.
Portability: The size and weight of a solution system must not exceed a reasonable proportion of the underlying vehicle's payload metrics. Its size must not exceed the size of the vehicle's payload cabin, and its weight must not exceed the vehicle's payload capacity.
Cost efficiency: The financial cost of a solution system must not exceed a reasonable proportion of the underlying vehicle.

### SUMMARY OF THE INVENTION

We present RadioRateTransformer (or RRTransformer), a commercial product built for implementing long-haul (≤30 km) and broadband (˜10 Mbps) data links, and in addition, multi-hop mobile ad hoc networks using these broadband links. Upon availability of such broadband network services, more advanced bandwidth-hungry applications, such as unmanned navigation, unmanned video monitoring and robotic operations, mobile ad-hoc broadband hotspots (non-3G/4G/5G hotspots), etc. can be implemented on mobile vehicles to cover most of the earth surface where the cellular networks are unavailable or underperforming.

RRTransformer/RadioRateTransformer is named after electric transformer. Like what happens in an electric transformer box where electric current of low voltage can be transformed into high voltage through electromagnetic effects, in an RRTransformer box a low-rate VHF/UHF radio link is transformed into a high-rate gigahertz broadband radio link.

The invention has already been implemented as actual commercial-off-the-shelf (COTS) products.

### BRIEF DESCRIPTION OF THE DRAWINGS

For a more complete understanding of the invention, reference is made to the following description and accompanying drawings, in which:

FIG. 1 A sample RRTransformer system comprised of gigahertz broadband radio (Ubiquiti Rocket M5 transceiver and AM-5G16-120 sector antenna), VHF/UHF radio (Baofeng UV-5R handheld unit) and a GPS receiver;

FIG. 2 A separated TCP/IP router box dedicated to VHF/UHF data communication (open box); and

FIG. 3 A separated TCP/IP router box dedicated to VHF/UHF data communication (closed box).

### DETAILED DESCRIPTION OF THE PREFERRED EMBODIMENTS

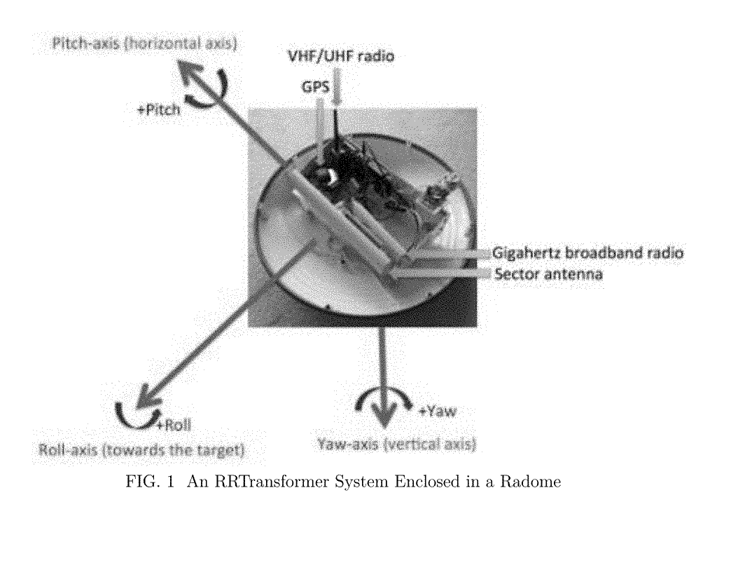

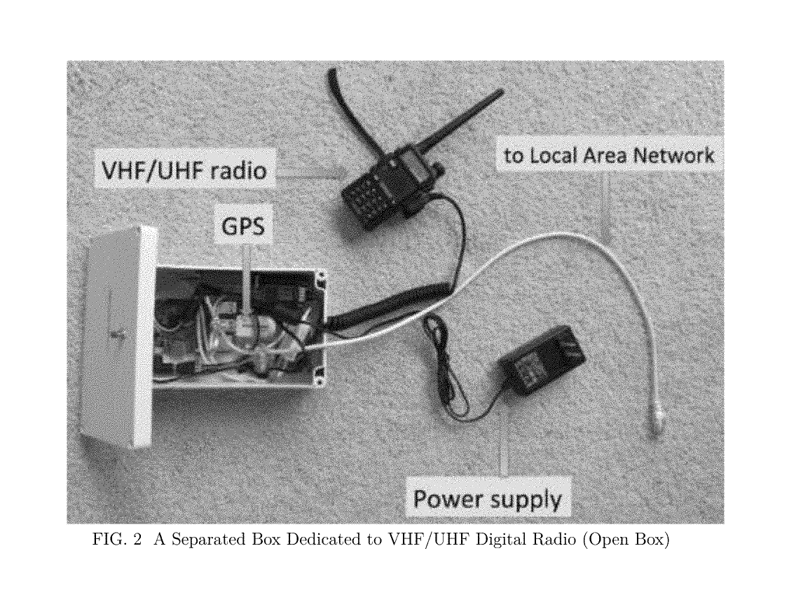

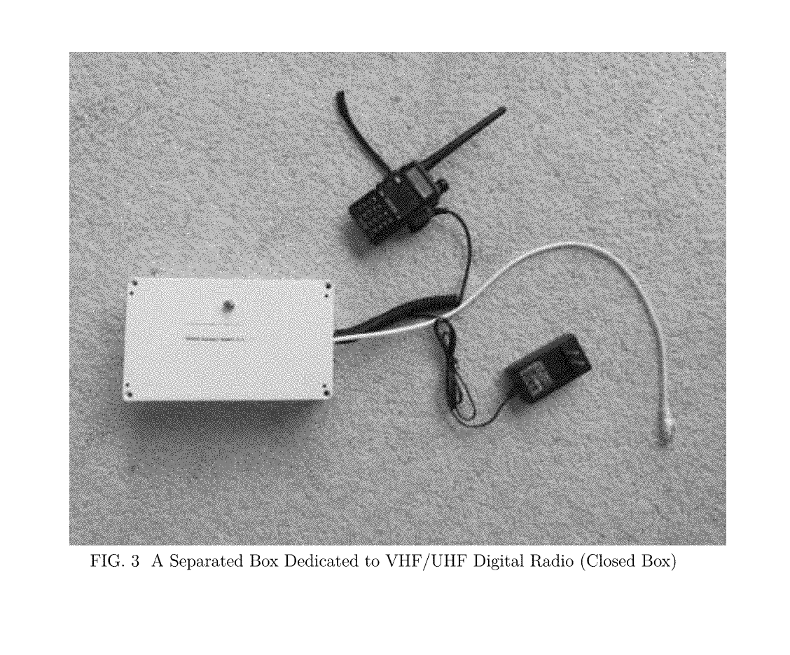

An RRTransformer is comprised of two main components:
1. There is an FCC-compliant VHF/UHF radio using its omni-directional antenna and low-rate (e.g., 1200 bps) link to broadcast control information proactively or reactively. Examples of the control information include the current vehicle's GPS coordinates and optionally the distance-vector routing table. The transmission range of a 8-watt handheld radio is at least 20 km LoS per our field tests, of a 25-watt mounted radio is at least 30 km LoS. The time lapse between two consecutive VHF/UHF broadcasts can be several minutes since it takes time for vehicles like automobiles to move out of the 20 km/30 km range. This parameter is user-configurable in the range of 5 seconds to any number of days. Our default setting is 5 minutes, so that, in an error-prone wireless environment with 50% packet delivery ratio, the neighboring vehicles know the vehicle's GPS coordinates approximately every 10 minutes.
2. There is an FCC-compliant gigahertz broadband radio using its high-gain directional antenna and the acquired GPS coordinates of a neighboring target to establish a high-speed directional link. The term “target” refers to either a neighboring vehicle who broadcasts its GPS coordinates using VHF/UHF radio or a fixed base station at a known position indexed by a well-known database. Our field test proved that a fixed 27 dBm Ubiquiti RocketM5 radio with 22 dBi sector antenna can achieve ˜10 Mbps rate to another moving 26 dBm RocketM5 with 16 dBi sector antenna at 16 km distance, or to another temporary fixed 27 dBm RocketM5 with 19 dBi sector antenna at 21 km distance. As depicted in FIG., the patented directional gigahertz radio system is comprised of four main parts: a proprietary embedded system made by our company (Turing Network Test L.L.C.), a COTS broadband communication device, several rotary mechanical drivers and an installation base. The provisional patent of the gigahertz broadband radio system itself is already granted under the application No. 62/449,099, and its non-provisional version is pending under the application Ser. No. 15/623,400.
(1) The proprietary embedded system functions as a network gateway for the vehicle's local area network. It has an accurate fluxgate compass to measure the current heading angle of the sector antenna, a GPS device to acquire its own geo-location coordinates and a TCP/IP protocol stack to communicate with other network nodes. Currently we are using KVHC100 fluxgate compass in our COTS product line. The accuracy of KVHC100 is ±0.5 degree. When two vehicles communicate with each other, they must do two tasks: (1) pre-storing the other vehicle's initial location coordinates in the local storage of the embedded system, and (2) exchanging its current location coordinates with the other vehicle every T seconds where T ranges from a few seconds for fast-moving vehicles to several hours for stationary nodes like fixed basestations. This way, a vehicle calculates the heading angle towards the other vehicle based on both sets of coordinates, then aims its directional antenna accordingly. In fact, our embedded system maintains a table of target coordinates, and aims the directional antenna towards the nearest target in the table.
   i. For example, when stationary base-stations/access-points are deployed in the customer's wireless Internet access scenarios, we currently demand that the customer must store all base-stations' coordinates as a table in each vehicle's local storage. The embedded system selects the nearest one from the table and aims the directional antenna towards the nearest base-station. Once furnished with GIS terrain capability, “the nearest” metric is redefined to be “the most optimal” metric, for example, to enforce the line-of-sight constraint by knowing the terrain and avoiding obstacles, and also to enforce various routing constraints in the routing protocol packets. We are not trying to patent the “the nearest”/“the most optimal” design in this application. The reason why it is mentioned is to show that our design is viable in the real world.
   ii. The coordinate information of a vehicle is textual data about 320 bits in size. We have developed a location coordinate broadcast protocol based on the long-range VHF/UHF digital radio being patented, which is capable of transmitting data in 1200 bit-per-second speed and delivering the 320-bit textual data within a few seconds. The VHF/UHF digital radio channel acts as a control channel that exchanges important location information to establish the broadband data channel.
(2) A broadband communication device is an FCC-certified COTS product available from manufacturers like Ubiquiti and Mikrotik. In particular, a 15±2 dBi COTS sector antenna is typically 0.35 meter in length/diameter and weighs about 1 kilogram. A 20±2 dBi COTS sector antenna is typically 0.75 meter in length/diameter and weighs about 5 kilograms.
(3) Sector antenna's horizontal rotary is a mechanical driver coping with yaw-rotations. It utilizes a slip-ring device to accomplish unbounded rotations around the yaw-axis. The horizontal rotary plate is fastened to the upper-half of a rotary bearing (e.g., a lazy susan bearing).
(4) The installation base is fastened to the lower-half of the rotary bearing.
   i. Optionally, the entire system can be enclosed in an external radome cover for maritime use and weather-proof purposes.
      A sample commercial product of our system is depicted in FIG. 1, where a VHF/UHF radio (Baofeng UV-5R with 2.15 dBi omni-directional antenna), a gigahertz broadband radio (Ubiquiti Rocket M5 transceiver and AM-5G16-120 sector antenna) and a GPS receiver are placed together on a mechanical rotary enclosed in a radome cover (upper half of the radome not shown). Since a VHF/UHF radio in our system uses omni-directional antenna, it is not necessary to place it on the rotary designed for directional antennas. FIG. 2 shows that we have implemented a separated box dedicated to the VHF/UHF radio, which can exchanges GPS coordinates with the other end of a data link and communicate with the local broadband radio on the rotary via 802.3 wired Ethernet LAN or 802.11 wireless LAN. FIG. 3 shows the appearance of the VHF/UHF radio box when the box is closed.

A single unit of a complete vehicular system can be enclosed in a portable (18-inch, 24-inch or 36-inch) radome and less than 15 kilograms in weight. These parameters serve the portability objective. At the time of the application filing, a single unit of a complete vehicular system is priced at US$3,900 for aerial rotorcrafts and blimps, at US$5,900 for automobiles and boats, or at US$12,900 for large ships. These parameters serve the cost-efficiency objective.

In this application, we are patenting the VHF/UHF and gigahertz broadband radio combo (i.e., the fully legal approach of using VHF/UHF omni-directional communication to establish a gigahertz broadband directional communication), but not the VHF/UHF radio system itself and the gigahertz broadband radio system itself. The patent application of the VHF/UHF radio components shown in FIG. 1 and the VHF/UHF radio box shown in FIG. 2 will be filed separately in the near future. The provisional patent of the gigahertz broadband radio system itself is already granted under the application No. 62/449,099, and its non-provisional version is pending under the application Ser. No. 15/623,400.

Caveats

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

What is claimed:

1. Suppose the line-of-sight between the transmitting vehicle and the receiving vehicle is true, our invention being patented uses a VHF/UHF radio to exchange the needed location information between the two vehicles so that their directional antennas of the gigahertz broadband radios can be precisely aligned to point to each other after precisely computing the 3-dimensional bearing angles. Unlike some devices currently sold on the market, all the technical parameters used in this VHF/UHF radio and gigahertz broadband radio combo system are legal, i.e., fully compliant to FCC rules (FCC 47CFR90, FCC 47CFR97, FCC 47CFR15), in particular in regard to the constraints on radio transceivers' transmission power and antenna gains.

2. A vehicle knows its own geo-location coordinates using GPS devices or equivalence. The system recited in claim 1 has implemented a proactive network protocol to exchange geo-location coordinates between the two communicating vehicles at real time with a fine granularity T, for example, T=10 seconds, so that a mobile vehicle can maintain the needed directional communication by computing the current heading angle towards the other side based on both vehicle's coordinates. T is user configurable to accommodate every specific scenario. T is in the range of minimal 5 seconds to maximal any number of days. The default value of T in our current COTS products is 300 seconds. Consequently, for a pair of mobile vehicles, whenever they can exchange geo-location coordinates using a rate-limited slow-speed VHF/UHF link, the system recited in claim 1 effectively establish a high-speed wireless broadband link between the two vehicles, hence transforms the rate-limited slow-speed VHF/UHF link into a rate-abundant high-speed broadband link.
